(19) United States
(12) Patent Application Publication
(10) Pub. No.: US 2022/0303669 A1
(43) Pub. Date: Sep. 22, 2022

(54) INSTRUMENT SPEAKER CABINET WITH ACTIVE AND PASSIVE RADIATOR SPEAKERS

(71) Applicant: CHERRY CREEK DOOR & WINDOW COMPANY, INC., Seattle, WA (US)

(72) Inventor: Paul Gulledge, Seattle, WA (US)

(21) Appl. No.: 17/203,520

(22) Filed: Mar. 16, 2021

(51) Int. Cl. H04R 1/28; H04R 9/06; H04R 1/02; H04R 7/20; H04R 9/02; H04R 3/00; H04R 7/12

(52) U.S. Cl. CPC H04R 1/2834; H04R 9/06; H04R 1/025; H04R 7/20; H04R 9/025; H04R 3/00; H04R 7/12; H04R 2400/11

(57) ABSTRACT

An instrument speaker cabinet includes a front face, two side faces opposite each other, and a rear face opposite the front face. An active speaker is embedded in the front face. A respective passive radiator speaker is embedded in each side face. The rear face has one or more input jacks for connecting to a musical instrument.

### BACKGROUND

### Technical Field

The present disclosure is related to musical instrument speaker cabinets, and more particularly to bass guitar instrument speaker cabinets.

### Description of the Related Art

Various systems, methods, and devices are utilized to amplify the sound produced by a musical instrument. In the example of a bass guitar, as the strings are played vibrations are transmitted to the bridge, saddle, and pickups of the bass guitar. These vibrations are then converted into audible sound waves that can be enjoyed by listeners. Under normal circumstance, the sounds may be too quiet to be clearly heard by listeners that are somewhat far away from the bass guitar. Accordingly, efforts are made to amplify the sounds in a way that can be heard by larger audiences while still retaining desired acoustic characteristics.

One possible way to amplify the sound of a bass guitar is to directly input the bass guitar into a public address (PA) system. Another possible method is to use a bass amplifier. However, amps and PA systems are often large and prohibitively heavy in order to reproduce the qualities of the bass guitar in a satisfactory manner.

### BRIEF SUMMARY

Embodiments of the present disclosure provide a lightweight, transportable instrument speaker cabinet that with the assistance of the side radiators actually amplifies the sound of a musical instrument in a manner that retains the audio characteristics of the musical instrument at a louder volume while retaining the audio characteristics of the musical instrument. The instrument speaker cabinet includes an active speaker and one or more passive radiator speakers. The active speaker is electrically connected or coupled to the musical instrument and amplifies the sound produced by the musical instrument via the bass amplifier. The one or more passive radiator speakers output audio sound waves based on pressures that are generated within the instrument speaker cabinet. The passive radiator speaker is a device that increases the low frequency response (i.e. Bass) of a speaker system. When used properly, the passive radiator can give the speaker system the comparable performance characteristics of a much larger system. A lot of air needs to be moved in order to produce audible bass frequencies. Traditionally, when it comes to bass production, a larger woofer means louder, clearer bass. The passive radiator is a reactionary device as the name suggests. When a driver (such as a subwoofer) is mounted to a sealed speaker box (enclosure), the physical forward/back movement of the speaker affects the internal air pressure of the enclosure. When a passive radiator is mounted to the same speaker box, the internal air pressure fluctuations (caused by the movement of the driving speaker) causes the passive radiator to begin moving forward/back as if it was also a driven speaker. When the passive radiator moves, it creates sound frequencies just as a normal driver does. Passive radiator systems can have the same sonic output as larger speaker cabinets, but in a much smaller size. When a passive radiator is tuned properly it can greatly enhance the sonic capabilities of a speaker in regards to low frequency production. This is because in order for a port tube to provide the same air mass as the speaker cone, the port tube may be physically large, which would require a larger speaker cabinet. The combination of the active speaker and the passive radiator speakers results in high-level audio quality output from the instrument speaker cabinet.

In one embodiment, the instrument speaker cabinet includes a front face, a rear face, and two side faces. The active speaker is coupled to or positioned adjacent to the front face. A first passive radiator speaker is coupled to a first of the two side faces. A second passive radiator speaker is coupled to a second of the two side faces. This results in the output of high quality instrument sound from the instrument speaker cabinet and combines added bass response with a small product footprint.

### BRIEF DESCRIPTION OF THE SEVERAL VIEWS OF THE DRAWINGS

FIG. 1 is a first perspective view of an instrument speaker cabinet, according to one embodiment.

FIG. 2 is a second perspective view of the instrument speaker cabinet, according to one embodiment.

FIG. 3 is a third perspective view of the instrument speaker cabinet, according to one embodiment.

FIG. 4 is a rear view of an interior of the instrument speaker cabinet, according to one embodiment.

FIG. 5 is a cross-sectional view of a front face of an instrument cabinet including an active speaker, according to one embodiment.

FIG. 6 is a cross-sectional view of a side face of an instrument speaker cabinet including a passive radiator speaker, according to one embodiment.

FIG. 7 is a flow diagram of a method for operating an instrument speaker cabinet, according to one embodiment.

FIG. 8 is a cross-sectional top-down view of an instrument speaker cabinet including a passive radiator speaker according to an embodiment.

### DETAILED DESCRIPTION

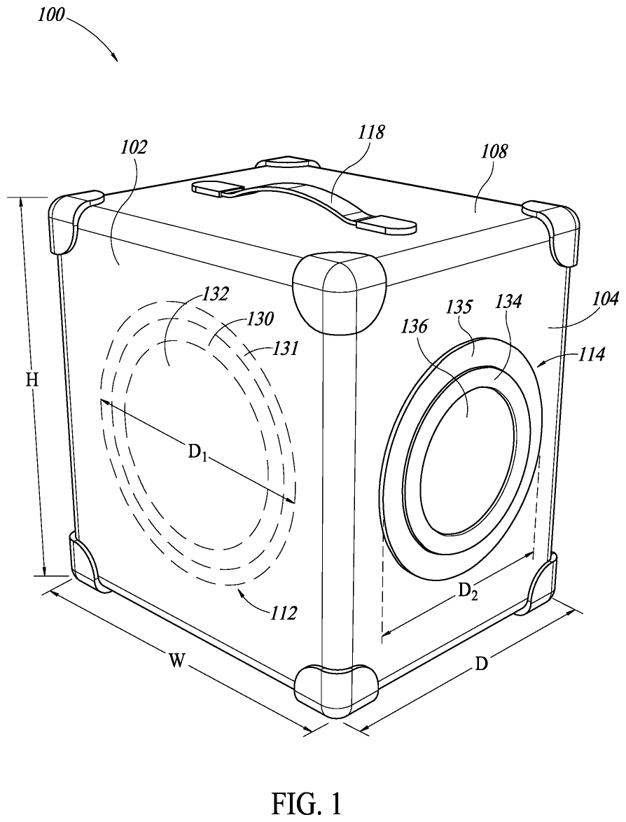

FIG. 1 is a perspective view of an instrument speaker cabinet 100, according to one embodiment. The instrument speaker cabinet 100 is configured to be electrically connected or coupled to a musical instrument, which may be a bass guitar. The instrument speaker cabinet 100 receives electrical signals from the musical instrument representing sounds generated by the musical instrument. The instrument speaker cabinet 100 generates and outputs soundwaves based on the electrical signals received from the musical instrument. In some examples in this disclosure, the instrument speaker cabinet 100 is a guitar speaker cabinet configured to be coupled to a guitar and to reproduce sounds generated by the guitar. However, the instrument speaker cabinet 100 can be utilized for musical instruments other than a guitar without departing from the scope of the present disclosure.

This instrument speaker cabinet 100 is lightweight and portable, such less than 20 pounds and preferably less than 15 pounds.

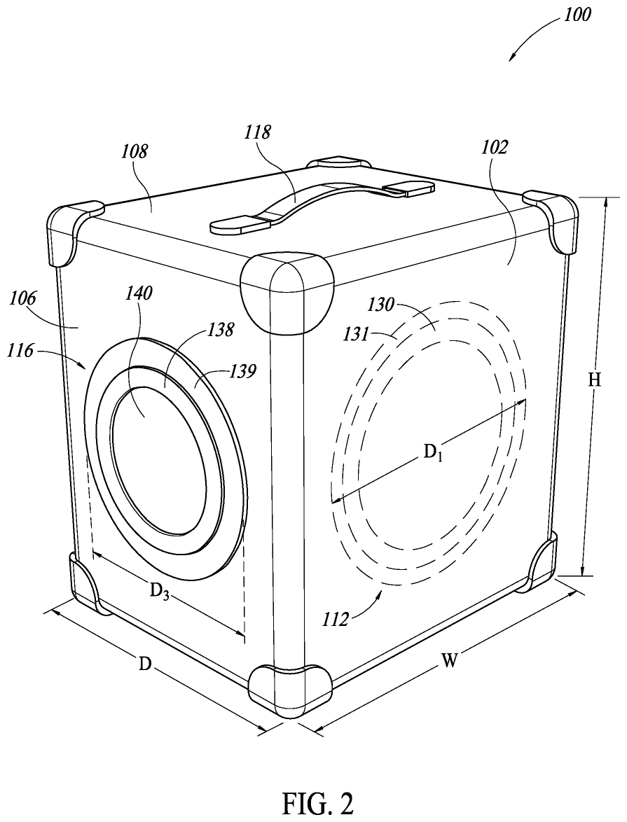

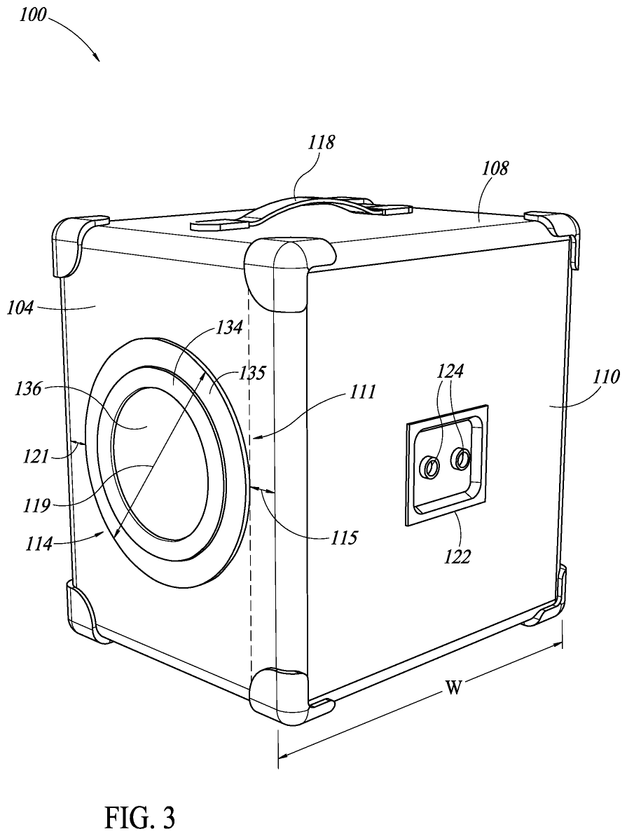

The instrument speaker cabinet 100 includes a front face 102, a first side face 104, a second side face 106 (see FIG. 2), a top face 108, and a rear face 110 (see FIG. 3). The perspective view of FIG. 1 shows only the front face 102, the first side face 104, and the top face 108. The front face is transverse to the first and second side faces. The first and second side faces are substantially parallel in some embodiments.

The instrument speaker cabinet 100 includes an active speaker 112 coupled to the front face 102. The active speaker 112 is represented in dashed lines in FIG. 1 because the front face 102 may include a covering that obscures the speaker. The covering may include a fabric or other material coupled to the front face. The front face 102 may be a mesh that has flexibility or resiliency that separates components of the speaker 112 from an external environment.

In alternative embodiments, the active speaker 112 may not be obscured by a covering and therefore may be visible on the front face 102 of the instrument speaker cabinet 100. The active speaker 112 may include a flexible surround 130 coupled to a frame 131. The frame 131 may be fixed to the front face 112. The active speaker 112 may also include a diaphragm 132 coupled to the surround 130. The active speaker 112 may have a diameter D1 corresponding to the outer diameter of the frame 131. Alternatively, the diameter D1 may correspond to the outer diameter of the surround 130 or the inner diameter of the surround 130.

The instrument speaker cabinet 100 has a height H. The height H of the instrument cabinet 100 can correspond to the height of the front face 102. The front face 102 has a width W. The width W of the front face 102 corresponds to the width of the instrument speaker cabinet 100. The diameter D1 of the active speaker 112 is less than the height H and the width W. In one embodiment, the height H is in the range of 10 inches and 15 inches. The width is in the range of 12 inches and 18 inches. The diameter D1 is in the range of 12 inches and 18 inches. Other values can be utilized for the height H and the diameter D1 without departing from the scope of the present disclosure.

The instrument speaker cabinet 100 includes a first passive radiator speaker 114 coupled to the first side face 104. Though not shown in FIG. 1, the first passive radiator speaker 114 may also be obscured by a covering in the same manner as the active speaker. In other words, a covering may be coupled to the first side face 104 obscuring the first passive radiator speaker 114. Differences between the first passive radiator speaker 114 and the active speaker will be set forth below.

The first passive speaker 114 may include a flexible surround 134 coupled to a frame 135. The first passive speaker 114 may also include a diaphragm 136 coupled to the surround 134. The first passive radiator speaker 114 may have a diameter D2 corresponding to the outer diameter of the frame 135. Alternatively, the diameter D2 may correspond to the outer diameter of the surround 134 or the inner diameter of the surround 134.

The speaker cabinet 100 includes a depth D. The depth D may correspond to the width of first side face 104. The first side face 104 has a same height as the front face 102. The diameter D2 of the first passive speaker 114 is less than a height H and the depth D. The depth D is in the range of 7 inches and 12 inches. The diameter D2 is in the range of 6 inches and 9 inches. The diameter D2 is less than the diameter D1.

In one embodiment, the height H is in the range of 11 inches and 13 inches. The width W is in the range of 13 inches and 15 inches. The diameter D1 is in the range of 9 inches and 11 inches. In one embodiment, the depth D is in the range of 8 inches and 10 inches. The diameter D2 of the first passive radiator speaker 114 is in the range of 7 inches and 9 inches. In one embodiment, the height H is in the range of 11 inches and 13 inches. The width W is in the range of 13 inches and 15 inches. The diameter D2 of the first passive radiator speaker 114 is in the range of 7 inches and 9 inches. Other values can be utilized for the height H, the width W, the depth D, the diameter D1, and the diameter D2 without departing from the scope of the present disclosure.

The top face 108 has dimensions corresponding to the width W and the depth D of the instrument speaker cabinet 100. A handle 118 may be coupled to the top face 108. The handle 118 enables an individual to conveniently carry the instrument speaker cabinet 100. The handle 118 can include plastic, leather, metal, or other types of materials.

FIG. 2 is a second perspective view of the instrument speaker cabinet 100 of FIG. 1, according to one embodiment. The view of FIG. 2 illustrates the second side face 106 adjacent to the front face 102.

The instrument speaker cabinet 100 includes a second passive radiator speaker 116 coupled to the second side face 106. Though not shown in FIG. 2, the second passive radiator speaker 116 may also be obscured by a covering in the same manner as the active speaker. In other words, a covering may be coupled to the second side face obscuring the second passive radiator speaker 116. This instrument cabinet does not include an amplifier within the housing and instead is configured to be coupled to a separate device that includes an amplifier. In one configuration, a user will couple their base guitar to the amplifier with a first cable and the amplifier will be coupled to the bass guitar instrument cabinet of the present disclosure with a second cable.

The second passive speaker 116 may include a flexible surround 138 coupled to a frame 139. The surround is an edge or lip that overlaps with a portion of the side 106 to securely hold the passive speaker in the opening. The second passive speaker 116 may also include a diaphragm 140 coupled to the surround 138. The second passive speaker 116 may have a diameter D3 corresponding to the outer diameter of the frame 139. Alternatively, the diameter D3 may correspond to the outer diameter of the surround 138 or the inner diameter of the surround 138.

The second side face 106 has a same height as the front face 102. The diameter D3 of the second passive radiator speaker 116 is less than the height H and the depth D. In one embodiment, the diameter D2 of the second passive radiator speaker is in the range of 7 inches and 9 inches. Other values can be utilized for the diameter D3 without departing from the scope of the present disclosure. The dimensions of the second passive speaker 116 may be substantially identical to the dimensions of the first passive radiator speaker 114. The diameter D3 may be less than or equal to the diameter D1 of the speaker 112.

FIG. 3 is a third perspective view of the instrument speaker cabinet 100 of FIG. 1, according to one embodiment. The view of FIG. 3 illustrates the rear face 110 of the instrument speaker cabinet 100. The rear face 110 includes a plate 122 including one or more input jacks or connectors 124. The one or more input jacks 124 can be configured to receive a connector coupling a musical instrument, such as a guitar, to the instrument speaker cabinet 100. The input jacks 124 can include configurations and dimension suitable for receiving standard or typical electrical connectors from an instrument. The input jacks 124 can, alternatively, have other dimensions and configurations in order to receive any desired type of electrical connector. In one embodiment, an electrical connector may include one or more wires connected to the musical instrument, and a male or female connector for coupling to the jacks 124 of the instrument speaker cabinet 100. Those of skill in the art will recognize, in light of the present disclosure, that many types of connectors can be utilized to connect an instrument speaker cabinet to a musical instrument.

FIG. 3 illustrates that the rear face 110 is adjacent to the first side face 104 and the top face 108. Though not shown, the rear face 110 is also adjacent to the second side face 106 and opposite the front face 102. FIGS. 1 to 3 illustrate the instrument speaker cabinet 100 of substantially cuboid in that the front face 102, the first and second side faces 104, 106, and the rear face 108 I'll have a same height H, that the front face 102 and the rear face 110 have a same width W, and that the first and second side faces 104 and 106 have a same width corresponding to the depth D of the instrument speaker cabinet 100. However, shapes and configurations other than cuboid can be utilized for the instrument speaker cabinet 100 without departing from the scope of the present disclosure.

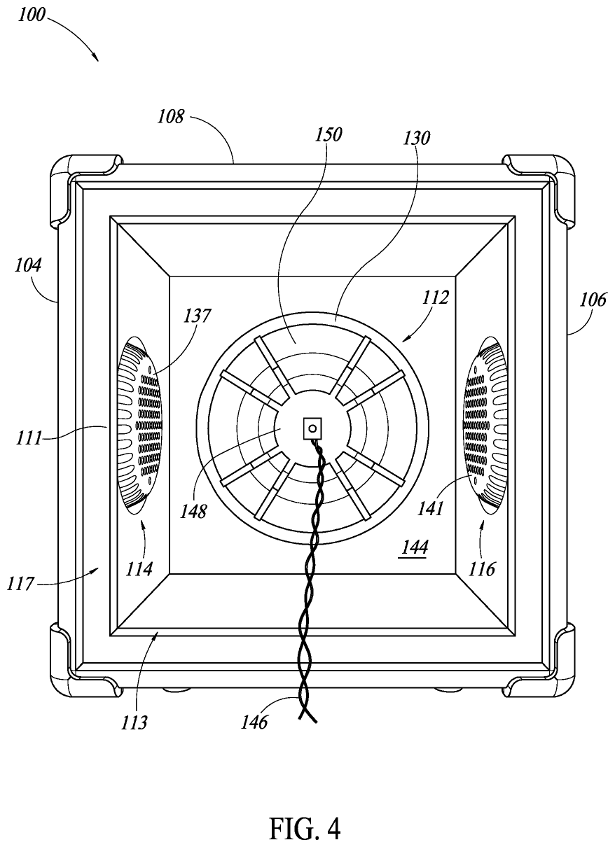

As can be viewed in FIGS. 3 and 4, the rear face 108 includes a support 111 that has a center portion removed to form an opening 113. The support may be a wooden frame or other material. Through the opening, an interior volume 144 can be accessed. The support 111 has a dimension 115 in a first direction that extends from an interior most surface to an exterior surface 117. Each of the other faces include a support that may be the same size and shape as the support 111, such that they have substantially equal thicknesses, i.e. the dimension 115.

The dimension 115 establishes an outer limit or boundary of the radiators 114. Said differently, an outermost diameter 119 of the radiator 114 is defined by the dimension 115 and a similar dimension 121 opposite to the dimension 115. The other dimension 121 corresponds to a thickness of a support or frame piece associated with the front face 102. The dimension D is a combination of the outermost diameter 119 of the radiator, the dimension 115, and the dimension 121. That is the radiator is as wide as a space between interior surfaces of the front and rear supports or frames. Alterative embodiments are described in more detail below.

FIG. 4 is a rear view of an interior of the instrument speaker cabinet 100 of FIG. 1, according to one embodiment. In the view of FIG. 4, the rear face 110 has been removed, thereby exposing an interior volume 144 of the instrument speaker cabinet 100. The view of FIG. 4 illustrates portions of the active speaker 112, the first passive radiator speaker 114, and the second passive radiator speaker 116 that are positioned within the interior volume 144 of the instrument speaker cabinet 100.

The active speaker 112 includes a housing 148 for the magnet and the voice coil of the active speaker 112. The magnet and the voice coil drive the active speaker 112. Wires 146 are coupled between the one or more jacks 124 and the voice coil of the active speaker 112. The voice coil is an electromagnet positioned within the housing 148. A permanent magnet is also positioned within the housing 148. The voice coil is positioned within a magnetic field generated by the permanent magnet. Electrical signals from the wires 146 because the voice coil to move back and forth within the magnetic field generated by the permanent magnet. The movement of the voice coil causes the active speaker 112 to generate soundwaves corresponding to the soundwaves generated by the instrument that is coupled to the instrument speaker cabinet 100. An amplifier may continually switch the polarity of one of the wires 146 in order to produce and magnify the movement of the voice coil within the housing 148. Those of skill in the art will recognize, in light of the present disclosure, that various configurations can be utilized to drive an active speaker without departing from the scope of the present disclosure.

The active speaker 112 also includes a cone 150. The cone 150 is coupled between the housing 148 of the voice coil magnet, and the support 130. The cone 150 assists in producing and guiding soundwaves. While FIG. 4 illustrates the wires 146 coupled directly to the housing 148 of the voice coil of permanent magnet, in practice, the wires 146 may be coupled to the various conductive portions of the cone 150 that are, in turn, coupled to the electromagnet.

The first passive radiator speaker 114 includes a shell 137. The second passive radiator speaker 116 includes a shell 141. The shells 137 and 141 may be substantially identical to each other. The shells 137 and 141 may include a plastic material, a metal material, or other suitable materials. The shells 137 and 141 may include apertures, groups, and slots.

As described previously, the first passive radiator speaker 114 and the second passive radiator speaker 116 are not embedded in a same face as the active speaker 112. Instead the first passes radiator speaker 114 is embedded in a first side face 104 adjacent to the front face 102. The second passive radiator speaker 116 is embedded in a second side face 106 adjacent to the front face 102 and opposite from the first side face 104.

An interior-most point of the cone 150 is further from an interior surface of the front face than an interior-most point of the first and second passive radiator speakers is from the first and second side faces, respectively. Each of the sides of the cabinet have a thickness or a dimension from the exterior surface to the interior surface. Each of the first and second radiators have a dimension from their exterior-most surface to their interior-most surface that is greater than the thickness of the respective sides. The rear side may include a lip or extension that frames the rear opening where the extension extends into the volume the same or more than the dimension of the first and second radiators. In one embodiment, a center of the speaker is substantially aligned with a center of the front face and a center of the first and second passive radiator speakers are substantially aligned with a center of the first and second sides.

The function of the first and second passive radiator speakers 114 and 116 will now be described in relation to the first passive radiator speaker 114. The first and second passive radiator speakers 114 and 116 function substantially identically to each other, so description of the first passive radiator speaker 114 will suffice to describe the function of the second passive radiator speaker 116.

The first passive radiation speaker 114 differs from the active speaker 112 in that the first passive radiation speaker 114 does not include a voice coil magnet. There are no electrical connections to the passive radiation speaker 114. Accordingly, electrical signals do not directly drive the passive radiation speaker 114, unlike the active speaker 112.

As the active speaker 112 is driven to produce soundwaves, air pressure variations arise within the interior volume 144 of the instrument speaker cabinet 100. The air pressure variations resulting from the active speaker 112 drive the first passive speaker 114. Depending on the dimensions of the instrument speaker cabinet 100 and the first passive speaker 114, the first passes FIG. 114 can enhance the quality of low frequency soundwaves (bass) emitted from the instrument speaker cabinet 100. The variations in air pressure cause the diaphragm 136 to flex. The flexing of the diaphragm 136 produces soundwaves. While the flexing of the diaphragm 136 can notably produce low frequency soundwaves of high quality, the diaphragm 136 can produce high-quality soundwaves of higher frequencies as well. As set forth previously, the second passive radiator speaker 116 operates in substantially the same manner as the first passive radiator speaker 114.

Embedding passive radiation speakers 114 on the side faces 104 and 106 adjacent to the front face 102 can provide several benefits. In an instrument speaker cabinet in which the diameter of an active speaker is greater than 50% of the height of the front face, additional large diameter speakers cannot be placed on the same face. The passive radiator speakers 114 and 116 can have a diameter similar to the diameter of the active speaker because they are placed on adjacent faces rather than on the same face as the active speaker 112. This can further enable the passive radiation speakers to output soundwaves having very low frequencies due to the larger diameters. Additionally, soundwaves can be output more effectively in lateral directions from the instrument speaker cabinet 100 due to the presence of the passive radiator speakers on the lateral faces of the instrument speaker cabinet 100. Furthermore, because the passive radiator speakers 114 and 116 are particularly suited to producing low frequency soundwaves, the larger wavelengths of the soundwaves enable them spread in all directions from the instrument speaker cabinet 100. These and other benefits can be achieved by utilizing an instrument speaker cabinet 100 including side-mounted passive radiation speakers 114 and 116 as described herein.

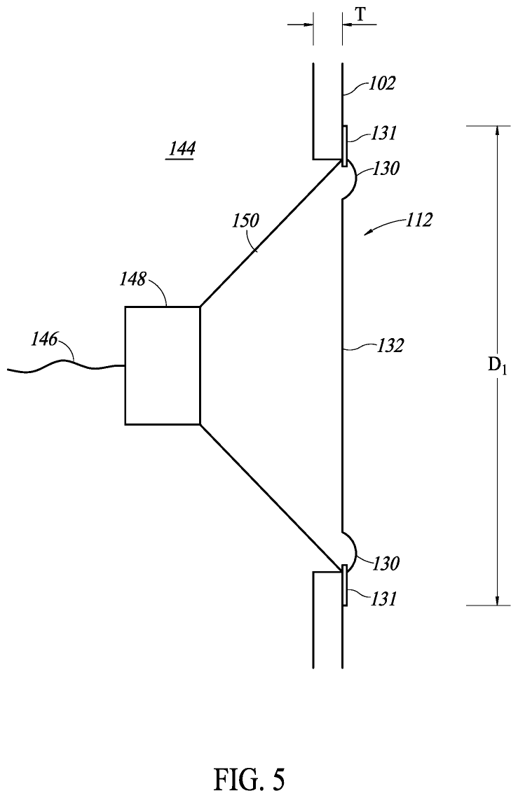

FIG. 5 is a simplified cross-sectional view of the active speaker 112 of the instrument speaker cabinet 100 of FIGS. 1-4, according to one embodiment. The active speaker 112 has a diameter D1, as described previously. The active speaker 112 may appear larger in FIG. 5 than in FIG. 1 due to the enlarged cross-sectional nature of FIG. 5. FIG. 5 does not illustrate the covering that covers the active speaker 112 in FIG. 1. The cover may be attached to a surface of the front face or may be attached to a frame added around the front fact to support the cover.

In one embodiment, the front face 102 has a thickness T. The can be in the range of ⅛ of an inch and 1 inch. The material of the front face 102 can include wood or other lightweight materials conducive to effective acoustics. In one embodiment, the material of the front face 102 is pinewood, though other types of one can be utilized. Materials other than what can also be utilized for the front face 102. The first and second side faces 104 and 106, the top face 108, and the rear face 110 can have the same material and thickness T as the front face 102.

The active speaker includes a diaphragm 132 coupled to an inner circumference of a flexible surround 130. The flexible surround 130 allows the diaphragm 132 to move axially (horizontally in FIG. 5). In the example of FIG. 5, axial motion of the diaphragm 132 is substantially parallel to an axis that passes through the center of the diaphragm 132 and extends in a horizontal direction in the view of FIG. 5. The flexible surround 130 can include a flexible plastic material that enables the surround 130 to flex and bend, thereby enabling flexing of the diaphragm 132. The diaphragm 132 can be made of plastics, paper, paper composites, or other suitable materials. In the example of FIG. 5 the diaphragm 132 is stretched between the surround 130. However, in some embodiments, the cone 150 can be the diaphragm of the active speaker 112. Those of skill in the art will recognize, in light of the present disclosure, that active speakers can include many configurations. These configurations fall within the scope of the present disclosure.

The surround 130 is coupled to a frame 131. The frame 131 is, in turn, fixed to the front face 102. Accordingly, the frame 131 fixes the active speaker 112 to the front face 102. The frame 131 can include metal, plastic, rubber, or other suitable materials. The active speaker 112 can also include a region shell coupled between the housing 148 and the front face 102. The cone 150 would be positioned within the region shell.

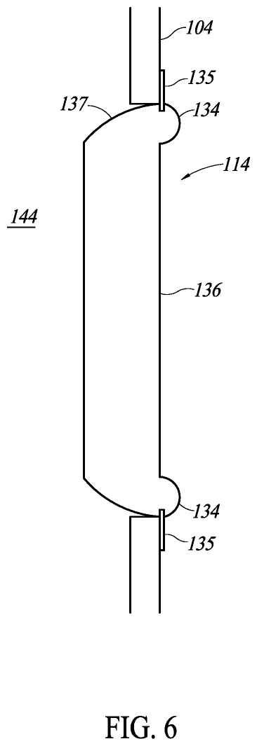

FIG. 6 is a simplified cross-sectional view of the first passive radiator speaker 114 of the instrument speaker cabinet 100 of FIGS. 1-5, according to one embodiment. The first passive radiator speaker 114 has a diameter D2, as described previously. The first passive radiator speaker 114 may appear larger in FIG. 6 than in FIG. 1 due to the enlarged cross-sectional nature of FIG. 6.

In one embodiment, the first side face 104 has the thickness T described in relation to FIG. 5, though in some embodiments the first side face 104 can have a thickness different than the front face 102. The material of the first side face 104 can be the same as the material of the front face 102.

The first passive radiator speaker 114 includes a diaphragm 136 coupled to an inner circumference of a flexible surround 134. The flexible surround 134 allows the diaphragm 136 to move axially (horizontally in FIG. 6). In the example of FIG. 6, axial motion of the diaphragm 136 is substantially parallel to an axis that passes through the center of the diaphragm 136 and extends in a horizontal direction in the view of FIG. 6. The flexible surround 134 can include a flexible plastic material that enables the surround 134 to flex and bend, thereby enabling flexing of the diaphragm 136.

The surround 134 is coupled to a frame 135. The frame 135 is, in turn, fixed to the first side face 104. Accordingly, the frame 135 fixes the active speaker 112 to the front face 102. The frame 135 can include metal, plastic, rubber, or other suitable materials. The first passive speaker 116 includes a shell 137 coupled to the frame 135. Alternatively, the shell 137 can be coupled to the flexible surround 134. Though not illustrated in FIG. 6, the passive radiator speaker 114 can include the cone coupled between the surround 134 and the shell 137. Those of skill in the art will recognize, in light of the present disclosure, that active speakers can include many configurations. These configurations fall within the scope of the present disclosure. The second passive radiator speaker 116 can be substantially identical to the first passive radiator speaker 114. Accordingly, a cross-sectional view of the second passive meter speaker 116 is not shown.

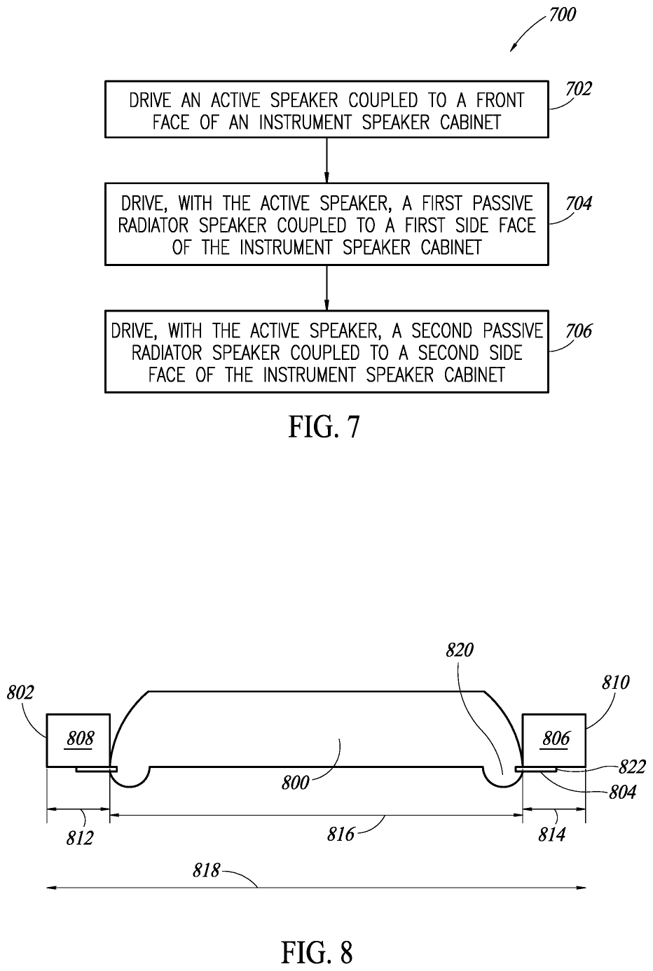

FIG. 7 is a flow diagram of a method 700 for operating an instrument speaker cabinet, according to one embodiment. At 702, the method 700 includes driving an active speaker coupled to a front face of an instrument speaker cabinet. At 704, the method 700 includes driving, with the active speaker, a first passive radiator speaker coupled to a first side face of the instrument Speaker. At 706, the method 700 includes driving, with the active speaker, a second passive radiator speaker coupled to a second side face of the instrument speaker.

FIG. 8 is a top-down cross-sectional view of a radiator 800 that is positioned between a front face 802 and a rear face 810 of an instrument cabinet. The radiator 800 includes a frame or exterior flange 804 that overlaps a first frame piece 808 associated with the front face 802 and a second frame piece 806 associated with the rear face 810.

Each of the first and second frame pieces may be a solid piece of wood or other material that form the support for a main speaker and a first and second radiator, as illustrated in other figures. The first frame piece has a first dimension 812 and the second frame piece has a second dimension 814. These first and second dimensions may be considered thicknesses of these frame pieces. The frame pieces delimit and define a boundary of the radiator. A diameter 816 of the radiator 800 is delimited by the first and second frame piece. A dimension 818 of a side face of this instrument cabinet equals the first dimension 812, the second dimension 814, and the diameter 816 of the radiator.

In this embodiment, the dimension 816 is associated with a diaphragm with a flexible surround or border 820. The exterior flange 804 may be embedded within the flexible surround or may be otherwise affixed or coupled to the flexible surround 820. The exterior flange partially overlaps the first and second frame pieces 808, 806. An end 822 of the exterior flange 804 is positioned between interior facing and exterior facing walls of the second frame piece 806. The radiator is a maximum size that can fit between the interior facing surfaces of the first and second frame pieces 808, 806.

Maximizing the radiator size within an efficiently sized and shaped bass guitar instrument cabinet creates additional bass with high quality sounds, with minimal weight added to the overall cabinet. The ratio of the radiator size to a size of each of the faces or walls of the cabinet is designed to maintain portability with improved sound production, including bass frequencies.

Embodiments of the present disclosure are directed to a bass guitar instrument cabinet that includes a single active speaker positioned and fixed to a first face and two passive radiator speakers of maximum size coupled to a third and fourth face of the cabinet. The cabinet does not include an amplifier and instead only includes the three speakers and any electrical components coupled to the single active speaker. The cabinet is configured to be coupled to an amplifier with a cable and the amplifier is coupled to the bass guitar with an instrument cable. The instrument cable may be a shielded cable. The shielding helps reduce unwanted noise interference from other electronics and radio signals nearby.

The single active speaker is configured to reproduce frequencies associated with a bass guitar as opposed to the entire sound spectrum. Instrument speakers tend to have heavier magnets compared to standard speakers. The various embodiments described above can be combined to provide further embodiments. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A system, comprising:
a bass guitar instrument speaker cabinet that includes:
a front face;
a rear face;
a first side face;
a second side face;
an active speaker coupled to the front face;
a first passive radiator speaker coupled to the first side face;
a second passive radiator speaker coupled to the second side face; and
an input jack coupled to the rear face and configured to connect the active speaker to a bass guitar.

2. The system of claim 1, wherein the active speaker includes a voice coil coupled to the input connector.

3. The system of claim 1, wherein the front face has a height in the range of 10 inches and 15 inches.

4. The system of claim 3, wherein the front face has a width in the range of 12 inches and 18 inches.

5. The system of claim 4, wherein the first and second side faces have a width in the range of 7 inches and 12 inches.

6. The system of claim 5, wherein the active speaker has a diameter in the range of 8 inches and 12 inches.

7. The system of claim 6, wherein the first and second passive radiator speakers have a diameter in the range of 6 inches and 9 inches.

8. The system of claim 1, wherein the input connector is configured to couple to a guitar.

9. The system of claim 1, wherein the bass guitar instrument speaker cabinet has a weight less than 20 lbs.

10. The system of claim 1, further comprising a top face.

11. The system of claim 1, further comprising a handle coupled to the top face.

12. A guitar cabinet comprising:
a front face having a height in the range of 11 inches and 13 inches;
an active speaker coupled to the front face and having a diameter in the range of 9 inches and 11 inches;
a first side face adjacent to the front face and having a width in the range of 8 inches and 10 inches;
a first passive radiator speaker coupled to the first side face and having a diameter in the range of 7 inches and 9 inches;
a second side face adjacent to the front face and having a width in the range of 8 inches and 10 inches; and
a second passive radiator speaker coupled to the second side face and having a diameter in the range of 7 inches and 9 inches.

13. The guitar cabinet of claim 12, wherein the first passive radiator speaker includes:
a frame coupled to the first side face, a flexible surround coupled to the frame, and a diaphragm coupled to the flexible surround.

14. The guitar cabinet of claim 12, further comprising a rear face opposite the front face and including a connector for connecting a guitar to the active speaker.

15. The guitar cabinet of claim 14, further comprising a wire coupled between the input connector and the active speaker.

16. The guitar cabinet of claim 12, wherein the active speaker includes a voice coil and a permanent magnet.

17. A method, comprising:
driving an active speaker coupled to a front face of an instrument speaker cabinet;
driving, with the active speaker, a first passive radiator speaker coupled to a first side face of the instrument speaker cabinet; and
driving, with the active speaker, a second passive radiator speaker coupled to a second side face of the instrument speaker cabinet.

18. The method of claim 17, further comprising:
connecting the active speaker to a musical instrument; and
driving the active speaker with electrical signals corresponding to sounds from the musical instrument.

19. The method of claim 17, wherein driving the first and second passive radiator speakers includes generating air pressure variations within an interior volume of the instrument speaker cabinet with the active speaker.

20. The method of claim 17, further comprising coupling a wire in the range of the active speaker and a connector of the instrument speaker cabinet.
